(19) United States
(12) Patent Application Publication
(10) Pub. No.: US 2025/0078873 A1
(43) Pub. Date: Mar. 6, 2025

(54) SYSTEMS AND METHODS TO INTEGRATE VISUAL AND AUDIO REPRESENTATIONS OF REAL-WORLD USERS INTO EXISTING MEDIA CONTENT

(71) Applicant: Shay Shabnam Fard, Los Angeles, CA (US)

(72) Inventor: Shay Shabnam Fard, Los Angeles, CA (US)

(21) Appl. No.: 18/460,603

(22) Filed: Sep. 4, 2023

(51) Int. Cl. G11B 27/036; G06T 11/00; G06T 13/00; G10L 13/033; H04N 21/44; H04N 21/45; H04N 21/81

(52) U.S. Cl. CPC G11B 27/036; G06T 11/00; G06T 13/00; G10L 13/033; H04N 21/44016; H04N 21/4532; H04N 21/8106; H04N 21/8146

(57) ABSTRACT

The objective is to provide a secure electronic online system featuring technology that enables users to utilize deepfake and voice-changing technology. This technology allows for the replacement of the original cast's face, color, figure, voice, accent, or language in movies, television series, reality shows, animations, music videos, and video games with their own, celebrities', or other individuals' features. The system is designed to integrate seamlessly with various streaming services and platforms for the purpose of selecting and modifying movies, television series, reality shows, animations, music videos, and video games.

### FIELD OF THE DISCLOSURE

The present disclosure relates to systems and methods to integrate visual and audio representations of real-world users into existing media content.

### BACKGROUND

Deepfaking may comprise a technique in which a face or body of a person in a movie or other content has been digitally altered so that they appear to be someone else, typically used maliciously or to spread false information.

### SUMMARY

One aspect of the present disclosure relates to a system configured integrate visual and audio representations of real-world users into existing media content in a fun and entertaining manner. The integration may be performed via deepfaking software, artificial intelligence, and/or other techniques. The media content may include movies, television shows, and/or other media content.

In some implementations, the system may include one or more of one or more servers, one or more client computing platforms, external resources, and/or other components. Server(s) may be configured to communicate with one or more client computing platforms according to a client/server architecture and/or other architectures. Client computing platform(s) may be configured to communicate with other client computing platforms via server(s) and/or according to a peer-to-peer architecture and/or other architectures. Users may access the system via client computing platform(s). In some implementations, users may access the features and/or functionality of the system based on information served to a client computing platform from the server(s), and/or based on an application program (“app”) downloaded to the computing platform

Deepfake software utilized by the system may be configured to allow users to replace the existing image and/or voice of the original actors in the movies or shows, and replace them with the celebrity of their choice and/or of them. For example, the user will have the opportunity to replace Daniel Craig in the movie “Spectre” and cast Henry Cavill to be James Bond in the movie.

First, a user utilizing the system may select a movie or show, then the user can select to replace the original cast. The user may select the actors through a library. In some implementations, the system may provide the ability to replace the characters/actors in the movies or shows with his/her own image or voice. For example, the user can replace Daniel Craig in the movie “Spectre” with his own face and watch the movie as if he is the fictional character James Bond.

When the user chooses to replace a main cast with his/her own image, he/she shall follow the instruction provided in an application program of the system and allow the software to read his/her facial expression. The user may be provided the option to keep the original voice or replace it with his/her own voice or another actor. For example, the user can keep Daniel Craig' voice while replacing his face with Henry Cavill in “Spectre.”

If the user chooses to replace the characters' voice with his/her own voice, he/she may follow the instructions on the application program and record his/her voice.

The system may be configured such that it restrictions restrict the user from changing some types of content and/or creating new content. For example, the app may be restricted from creating news content. Accordingly, permissions and/or restrictions may only allow the features and/or functionally presented herein to apply to entertainment content which an appropriate license may have been obtained.

The system may be configured to change/switch the voice on songs and/or singing elements within the media content. For example, a user can change the voice of Ryan Gosling in the movie “La La Land” where he is singing.

The system may be configured to change the voice of the artist on songs and/or music videos as well.

In accordance with one or more implementations, the media content stays as original, while the user may only have the ability to replace the image and voice on the existing contents.

The system's features and/or functionality may be used for both of colored and/or black-and-white media.

The system's features and/or functionality may be usable on media content including one or more of movies, TV shows, short films, music videos, reality shows, and/or songs that may be available through streaming services in the United States and Worldwide.

The user may download the app on his/her computing platform (e.g., smart phone), and/or log in to his/her account on a computing platform or smart TV to enable the features and/or functionally presented herein

The system's features and/or functionality may to integrated with platforms that he/she uses to stream media content, such as shows and/or movies. These streaming platforms may include, but are not limited to, one or more of NETFLIX, HULU, DISNEY+, TUBI, PEACOCK, PARAMOUNT+, APPLE TV+, PRIME VIDEOS, DC UNIVERSE INFINITE, HBO MAX, STARZ, FUBOTV, CURIOSITY STREAM, PLEX, YOUTUBE TV, PLUTO TV, SLING TV, CRACKLE, BILIBILI, WETV, IQIYI, YOUKU, RAKUTEN TV, LINE TV, VIU, ZEE5, HOTSTAR, MUBI, GLOBO PLAY, STAN, SHOWMAX, CANAL+, SKY GO, ALT BALAJI, PHILO TV, KOCOWA+, PANTAYA, ACRON TV, SHUDDER, MHZ CHOICE, and/or other platforms.

In some implementations, if the user decides to replace the original casts with the face of his/her friends or relatives, the system may require the communication of text or email invitations to those individual(s) in order to get permission. The system may require a recipient to acknowledge and/or confirm their consent for their likeness to be used. In some implementations, the recipient may be one or more of the following responses: 1) Deny the request, 2) Accept only for a specific movie or content, 3) Allow the user to use his/her image and/or voice on any content available on streaming services, and/or other responses.

After the recipient of the invitation agrees, he/she may submit his/her facial expression and/or audio through the application on a computing platform (their personal computing platform and/or a computing platform associated with the sender).

In some implementation, multiple users have the ability to watch the same movie and replace the characters at the same time. For example, family members in different locations will have the ability to log in for the same movie. For multiple users, one person must be the host and send the invitation to others, similar to video conference applications, like ZOOM. The family will be able to see each other's video at the corner and decide who is going to take over which character in the movie

The software may have the ability to take the human image and turn it to animation (e.g., computer-generated synthetic content). For example, if the user wishes to be Elsa on “FROZEN”, the software may be configured to transform his/her face to animation, and replace Elsa's computer-generated face with his/her computer-generated face. Accordingly, animated characters may be replaced with computer-generated representations of real-world user.

The software primary use is for entertainment. Enabling users to recast their favorite movies and TV shows by recasting them with celebrities or even their own faces and voices. Modify the original cast's voices with new ones or their own unique voice. Transform accents of the original cast as desired. Experience the films with younger or older versions of the actors.

The software may have the ability to be used for education. Offering a tool for crafting educational content. For example, teachers can leverage the software to design interactive learning experiences, enabling students to immerse themselves in historical events or scientific experiments. By integrating their own presence into these contexts, students can achieve a deeper understanding of the subjects, resulting in more engaging and impactful learning. Moreover, students can replace the faces and voices of instructors in educational videos with their favorite celebrities, adding a fun and creative element to the learning process.

The software may have the ability to be used for marketing. Enabling brands to create impactful marketing content. This content is customized to individual preferences, establishing deeper connections with potential customers, including factors such as culture, religion, and geographic location. For example, the software may allow changing wine in a movie, as alcohol is forbidden in some countries, and replacing it with a non-alcoholic beverage.

In some implementations, users can utilize the software to modify the acting style. For example, users will have the option to substitute Daniel Craig with Henry Cavill as James Bond in the movie “Spectre” and choose the acting styles of Tom Hanks for viewing the film.

The system's features and/or functionality could potentially integrate with movie theaters, allowing users the ability to modify movies while watching them in the theater. These theaters could include, but are not limited to, establishments such as AMC THEATRES, REGAL CINEMAS, CINEWORLD GROUP, CINEPLEX, CGV CINEMAS, CINEMARK THEATRES, VUE CINEMAS, WANDA CINEMAS, PVR CINEMAS and/or other theaters.

The system's features and/or functionality may incorporate VR technology, allowing the audience to dynamically recast movies in real-time while watching them at theaters. This creates an interactive cinematic adventure.

In some implementations, the software can enable users to generate virtual actors. For example, users can craft characters with attributes resembling Jennifer Lawrence, voice reminiscent of Jennifer Lopez, and acting style reminiscent of Meryl Streep.

In some implementations, the software can enable users to propose their own stories or movie genres, giving life to their creative concepts. By selecting elements from existing films, the audience can unleash their creativity and curate a distinctive cinematic experience. For example, a user might request a two-hour romantic comedy movie about two office workers involved in a car accident that erases their memories. The user can even choose actors like Brad Pitt and Megan Fox for the movie. The software then draws from various existing movies, such as ‘Crash,’ ‘Dumb and Dumber,’ ‘Love Story,’ and an episode of ‘The Office.’ Seamlessly editing these movies to one, the software offers the user a unique cinematic creation.

In some implementations, the system may be configured to give the ability to the users to change their accents. For example, a user wishes to replace her face and voice with Emilia Clark in the movie “Me before you”. If the user does not have a British accent like Emilia Clark and wishes to watch the movie with her voice and British accent, she can select to keep her own voice and turn her accent to the British accent. The user will have the ability to choose different accents available in a library. The user will have the ability to choose different languages available in a library and watch the movie in any language of his/her choice.

In some implementations, the system itself may comprise a streaming service and we will allow the users to select the contents from a platform that is part of the system.

In some implementations, in order to make movies, the system may not use the traditional format of having named actors playing in the movies. In order to make movies and content suitable for this platform, the system may use actors to film an entire movie in green suits and will allow the audience to choose their cast on the movies.

In some implementations, the system may serve as a focus group to get the necessary data from users in order to understand the audience's wants and desires for content, actors, and/or characters in the movies and TV shows in order to help studios to cast and market movies according to customer's wants and desires.

As used herein, any association (or relation, or reflection, or indication, or correspondence) involving servers, processors, client computing platforms, and/or another entity or object that interacts with any part of the system and/or plays a part in the operation of the system, may be a one-to-one association, a one-to-many association, a many-to-one association, and/or a many-to-many association or N-to-M association (note that N and M may be different numbers greater than 1).

As used herein, the term “obtain” (and derivatives thereof) may include active and/or passive retrieval, determination, derivation, transfer, upload, download, submission, and/or exchange of information, and/or any combination thereof. As used herein, the term “effectuate” (and derivatives thereof) may include active and/or passive causation of any effect. As used herein, the term “determine” (and derivatives thereof) may include measure, calculate, compute, estimate, approximate, generate, and/or otherwise derive, and/or any combination thereof.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured to integrate visual and audio representations of real-world users into existing media content, in accordance with one or more implementations.

FIG. 2 illustrates a method to integrate visual and audio representations of real-world users into existing media content, in accordance with one or more implementations.

### DETAILED DESCRIPTION

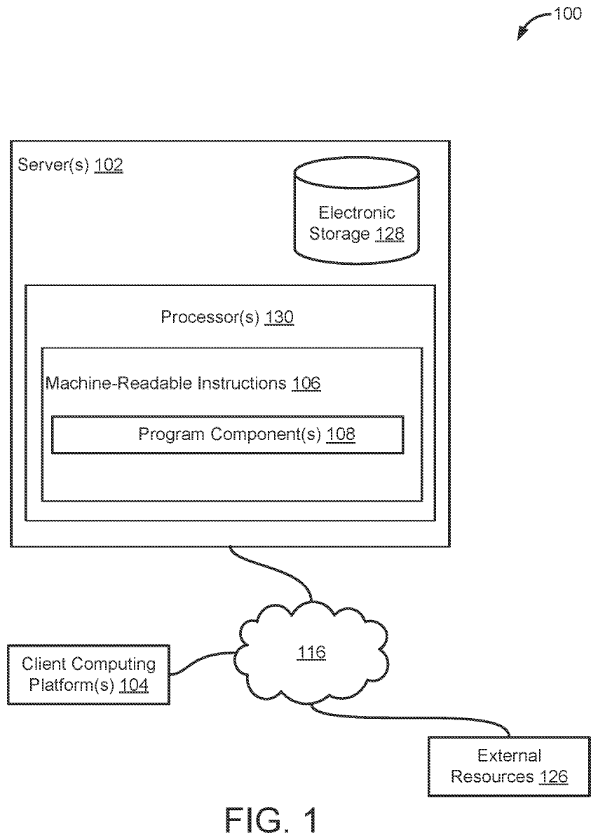

FIG. 1 illustrates a system 100 configured to integrate visual and audio representations of real-world users into existing media content, in accordance with one or more implementations. The disclosure proposes a secure electronic online system 100 featuring technology which allows the users to use deepfake and/or voice changing technology to replace the face, figure, voice, and/or the accent of the original cast in media content such as movies, television series, reality shows, animations, music videos, video games, and/or other media content, and replacing them with their own and/or celebrities or other individual's face, figure, voice, and/or accent. The system 100 may integrate with streaming services and platforms to select and modify media content such as movies, television series, reality shows, animations, music videos, video games and/or other media content.

In some implementations, system 100 may include one or more of one or more servers 102, one or more client computing platforms 104, external resources 126, and/or other components. Server(s) 102 may be configured to communicate with one or more client computing platforms 104 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104. Server(s) 102 may include one or more of non-transitory electronic storage 128, one or more processors 130 configured by machine-readable instructions 106, and/or other components.

In FIG. 1, machine-readable instructions 106 of one or more processors 130 of server(s) 102 may include one or more instruction components. The instruction components may include one or more computer program components 108. Executing the machine-readable instructions 106 may cause server(s) 102 to facilitate integrating visual and audio representations of real-world users into existing media content. In some implementations, individual client computing platforms may download machine-readable instructions that are the same as or similar to machine-readable instructions 106 so as to provide the features and/or functionality of server(s) 102 as local features and/or functionality at individual client computing platforms.

The non-transitory electronic storage 128 may be configured to store one or more of information libraries, content libraries, language libraries, and/or other information utilized by the system 100 and/or described herein.

In some implementations, non-transitory electronic storage 128 may be configured to store profile information and/or other information. The profile information may define one or more of user-visual information, user-audio information, and/or other information. The user-visual information may define visual characteristics of a user. By, the user-visual information may be in the form of one or more images and/or video depicting the user. The user-audio information may define audio characteristics of the user. By way of non-limiting illustration, user-audio information may comprise an audio recording of the user speaking, signing, uttering words, and/or other audio input.

In some implementations, the visual characteristics of the user may be computer-generated animations. The computer-generated animations for the visual characteristics of the user may be generated from a real-world image of the user.

In some implementations, the visual characteristics of the other entity may be computer-generated animations. In some implementations, the visual characteristics of the other entity are real-world images. In some implementations, the audio characteristics of the other entity are synthetic audio. In some implementations, audio characteristics of the other entity are real-world recorded audio.

The program component(s) 108 may be configured to obtain media content selected by a user. The media content may be obtained from a content library stored locally within server(s) 102, and/or from an external resource, such as a streaming platform. The media content may depict at least one character. The media content may include one or both of visual representations of the character and/or audio representations of the character. The character may include a real-world actor and/or a computer-generated animated character. The audio representations of the character may include record real audio content and/or synthetically generated content.

The program component(s) 108 may be configured to identify, within the media content, individual instances of the visual representations and/or audio representations of the character. In some implementations, identifying individual instances of the visual representations may comprise identifying individual frames, sequences of frames, and/or other content. In some implementations, identifying individual instances of the audio representations may comprise identifying time stamps within source audio, audio segments, and/or other content.

The program component(s) 108 may be configured to, for each of the instances of the visual representations of the character, effectuate a replacement the visual representations of the character in the media content with the visual characteristics of the user and/or other entities (e.g., of another real-world person, a celebrity, an animated character, etc.). The replacement may be done via deepfake software and/or other techniques. The term “replacement” may mean that the character is replaced entirely, and/or that a portion of the character (e.g., the face) is replaced or modified.

The program component(s) 108 may be configured to, for each of the instances of the audio representations of the character, effectuate a replacement the audio representations of the character in the media content with the audio characteristics of the user and/or other audio (e.g., of another real-world person, a celebrity, an animated character, etc.). The replacement may be done via deepfake software and/or other techniques. In some implementations, the replacement may include deleting original audio and providing new audio. In some implementations, the replacement may include overlaying original audio with new audio. In some implementations, the replacement may include silencing original audio and adding new audio. In some implementations, the replacement may include modifying original audio.

The program component(s) 108 may be configured to format and/or save modified media content. The modified media content may include the media content as modified by the replacement of the visual representations of the character in the media content with the visual characteristics of the user, and/or the replacement the audio representations of the character in the media content with the audio characteristics of the user.

The program component(s) 108 may be configured to effectuate a playback of the modified media content via the one or more client computing platforms 104.

The program component(s) 108 may be configured to effectuate presentation of individual user interfaces on individual client computing platforms of one or more client computing platforms 104. For example, the individual client computing platforms may access a user interface over network 116. A given user interface may be configured to facilitate one or more features and/or functionality presented herein. An instance of a user interface may include one or more user interface portions. By way of non-limiting illustration, a user interface may include one or more of an input portion, a display portion, and/or other portions. Individual portions may include one or more user interface elements configured to facilitate user interaction with the user interface. By way of non-limiting illustration, user interface elements may include one or more of text input fields, drop down menus, check boxes, display windows, virtual buttons, and/or other elements configured to facilitate user interaction.

An input portion of a user interface may be configured to obtain user input. User input may include one or more of profile information (to set up and/or access an account) and/or other information, search queries to search one or more libraries, requests to playback modified media content, send requests or notifications to other users, and/or other input.

In some implementation, user interface may be configured to walk a user through one or more displays in order to gather the information required to carry out one or more features and/or functionality described herein. By way of non-limiting illustration, a walkthrough may guide a user to input profile information by one or more of taking a video and/or images of themselves, speaking into a microphone, and/or other guidance.

The program component(s) 108 may be configured to obtain one or more user-provided search queries. The search queries may include one or more of media content, actors, voices, accents, and/or other content that may be present in one or more libraries stored by the system 100.

The program component(s) 108 may be configured to search the libraries based on the search queries and return results of the search queries.

The program component(s) 108 may be configured to generate new profiles and/or accounts for the users. The program component(s) 108 may be configured to effectuate communication of notifications to individual client computing platforms of one or more client computing platforms 104. The notifications may be generated and/or communicated responsive to requests to participate in the system 100. The instructions may include one or more of confirming identity, inputting profile information, electronically signing documents, and/or other information. The program component(s) 108 may be configured to obtain entry and/or selection by the users to accept, deny, and/or modify requests to participate.

The program component(s) 108 may be configured to effectuate one or more other features and/or functionally described herein

Returning to FIG. 1, in some implementations, server(s) 102, client computing platform(s) 104, and/or external resources 126 may be operatively linked via one or more electronic communication links. For example, such electronic communication links may be established, at least in part, via a network 116 such as the Internet and/or other networks. It will be appreciated that this is not intended to be limiting, and that the scope of this disclosure includes implementations in which server(s) 102, client computing platform(s) 104, and/or external resources 126 may be operatively linked via some other communication media.

A given client computing platform 104 may include one or more processors configured to execute computer program components. The computer program components may be configured to enable an expert or user associated with the given client computing platform 104 to interface with system 100 and/or external resources 126, and/or provide other functionality attributed herein to client computing platform(s) 104. By way of non-limiting example, a given client computing platform may include one or more of a desktop computer, a laptop computer, a handheld computer, a tablet computing platform, a NetBook, a Smartphone, a gaming console, and/or other computing platforms. A given client computing platform may include one or more of a camera, a microphone, a display screen, and/or other components.

External resources 126 may include sources of information outside of system 100, external entities participating with system 100, one or more media streaming platforms, and/or other resources. In some implementations, some or all of the functionality attributed herein to external resources 126 may be provided by resources included in system 100.

Server(s) 102 may include electronic storage 128, one or more processors 130, and/or other components. Server(s) 102 may include communication lines, or ports to enable the exchange of information with a network 116 and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 128 may comprise non-transitory storage media that electronically stores information. The electronic storage media of electronic storage 128 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 128 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 128 may include one or more virtual storage resources (e.g., cloud storage, a virtual private network, and/or other virtual storage resources). Electronic storage 128 may store software algorithms, information determined by processor(s) 130, information received from server(s) 102, information received from client computing platform(s) 104, and/or other information that enables server(s) 102 to function as described herein.

Processor(s) 130 may be configured to provide information processing capabilities in server(s) 102. As such, processor(s) 130 may include one or more of a digital processor, an analog processor, a digital circuit designed to process information, an analog circuit designed to process information, a state machine, and/or other mechanisms for electronically processing information. Although processor(s) 130 is shown in FIG. 1 as a single entity, this is for illustrative purposes only. In some implementations, processor(s) 130 may include a plurality of processing units. These processing units may be physically located within the same device, or processor(s) 130 may represent processing functionality of a plurality of devices operating in coordination. Processor(s) 130 may be configured to execute component(s) 108 and/or other components. Processor(s) 130 may be configured to execute component(s) 108 and/or other components by software; hardware; firmware; some combination of software, hardware, and/or firmware; and/or other mechanisms for configuring processing capabilities on processor(s) 130. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although component(s) 108 are illustrated in FIG. 1 as being implemented within a single processing unit, in implementations in which processor(s) 130 includes multiple processing units, one or more of component(s) 108 may be implemented remotely from the other components. The description of the functionality provided by the different component(s) 108 described below is for illustrative purposes, and is not intended to be limiting, as any of one of the component(s) 108 may provide more or less functionality than is described. For example, one or more of components may be eliminated, and some or all of its functionality may be provided by other ones of components. As another example, processor(s) 130 may be configured to execute one or more additional components that may perform some or all of the functionality attributed to a single component.

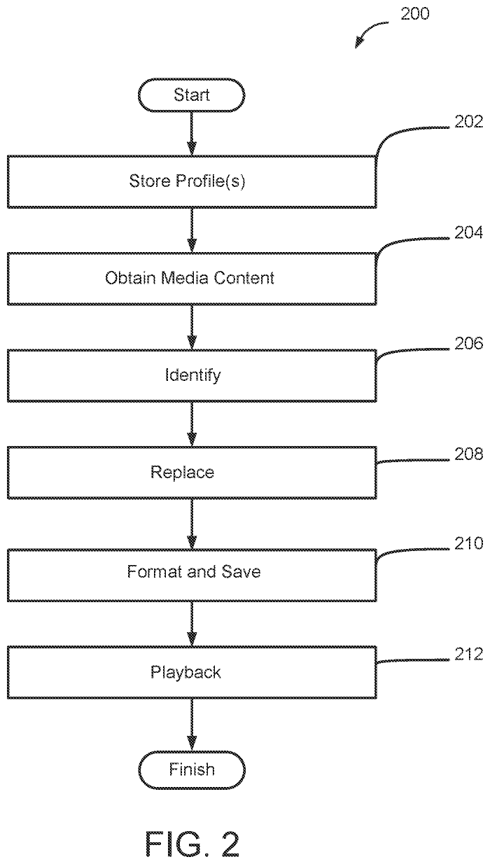

FIG. 2 illustrates a method 200 to integrate visual and audio representations of real-world users into existing media content, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 may include storing profile information, the profile information defining user-visual information and user-audio information, the user-visual information defining visual characteristics of a user, the user-audio information defining audio characteristics of the user. Operation 202 may be performed by one or more hardware processors configured by machine-readable instructions including a component that is the same as or similar to program component(s) 108 (shown and described in FIG. 1), in accordance with one or more implementations.

An operation 204 may include obtaining media content selected by a user, the media content depicting at least one character, the media content including visual representations and audio representations of the character. Operation 204 may be performed by one or more hardware processors configured by machine-readable instructions including a component that is the same as or similar to program component(s) 108 (shown and described in FIG. 1), in accordance with one or more implementations.

An operation 206 may include identifying, within the media content, instances of the visual representations and audio representations of the character. Operation 206 may be performed by one or more hardware processors configured by machine-readable instructions including a component that is the same as or similar to program component(s) 108 (shown and described in FIG. 1), in accordance with one or more implementations.

An operation 208 may include, for each of the instances of the visual representations of the character, effectuate a replacement the visual representations of the character in the media content with the visual characteristics of the user. Operation 208 may further include, for each of the instances of the audio representations of the character, effectuate a replacement the audio representations of the character in the media content with the audio characteristics of the user. Operation 208 may be performed by one or more hardware processors configured by machine-readable instructions including a component that is the same as or similar to program component(s) 108 (shown and described in FIG. 1), in accordance with one or more implementations.

An operation 210 may include formatting and/or saving modified media content. The modified media content may include the media content reflecting the replacement of the visual representations of the character in the media content with the visual characteristics of the user, and the replacement the audio representations of the character in the media content with the audio characteristics of the user. Operation 210 may be performed by one or more hardware processors configured by machine-readable instructions including a component that is the same as or similar to program component(s) 108 (shown and described in FIG. 1), in accordance with one or more implementations.

An operation 212 may include effectuating a playback of the modified media content. Operation 212 may be performed by one or more hardware processors configured by machine-readable instructions including a component that is the same as or similar to program component(s) 108 (shown and described in FIG. 1), in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

An operation 210 may include formatting and/or saving modified media content. The modified media content may include the media content reflecting the replacement of the visual representations of the character in the media content with the visual characteristics of the user, and the replacement the audio representations of the character in the media content with the audio characteristics of the user. Operation 210 may be performed by one or more hardware processors configured by machine-readable instructions including a component that is the same as or similar to program component(s) 108 (shown and described in FIG. 1), in accordance with one or more implementations.

An operation 212 may include effectuating a playback of the modified media content. Operation 212 may be performed by one or more hardware processors configured by machine-readable instructions including a component that is the same as or similar to program component(s) 108 (shown and described in FIG. 1), in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system configured to integrate visual and audio representations of real-world users into existing media content, the system comprising:
non-transitory electronic storage storing profile information, the profile information defining user-visual information and user-audio information, the user-visual information defining visual characteristics of a user and/or an other entity, the user-audio information defining audio characteristics of the user; and one or more physical processors configured by machine-readable instructions to:
obtain media content selected by a user, the media content depicting at least one character, the media content including visual representations and audio representations of the character;
identify, within the media content, instances of the visual representations and audio representations of the character;
for each of the instances of the visual representations of the character, effectuate a replacement the visual representations of the character in the media content with the visual characteristics of the user and/or the other entity;
for each of the instances of the audio representations of the character, effectuate a replacement the audio representations of the character in the media content with the audio characteristics of the user and/or the other entity;
format and save modified media content including the media content reflecting the replacement of the visual representations of the character in the media content with the visual characteristics of the user and/or the other entity, and the replacement the audio representations of the character in the media content with the audio characteristics of the user and/or the other entity; and effectuate a playback of the modified media content.

2. The system of claim 1, the replacement of the visual representations of the character in the media content with the visual characteristics of the user and/or the other entity; and/or the replacement the audio representations of the character in the media content with the audio characteristics of the user and/or the other entity are accomplished via deepfake software.

3. The system of claim 1, wherein the visual representations of the character are computer-generated animations, and the visual characteristics of the user that replace the visual representations of the character are computer-generated animations.

4. The system of claim 3, wherein the computer-generated animations for the visual characteristics of the user are generated from a real-world image of the user.

5. The system of claim 1, wherein the visual characteristics of the other entity that replace the visual representations of the character are computer-generated animations.

6. The system of claim 1, wherein the visual characteristics of the other entity that replace the visual representations of the character are real-world images.

7. The system of claim 1, wherein the audio characteristics of the other entity that replace the audio representations of the character are synthetic audio.

8. The system of claim 1, wherein the audio characteristics of the other entity that replace the audio representations of the character are real-world recorded audio.

9. The system of claim 1, provides the possibility of retaining the original character's audio while allowing users to modify the accent to their preferred choice, all while maintaining the original voice and tone.

10. The system of claim 1, provides the possibility to replace characters with either younger or older versions of the original cast.

11. The system of claim 1, wherein the visual representations of the product are altered, leading to the substitution of the original product in the movie or TV show with a similar item from a different brand.

12. The system of claim 1, provides the possibility to keep the visual representations of the character in the media content, preserving either the original visual attributes or the users' characteristics, while also allowing for the transformation of the acting style to match that of another character.

13. The system of claim 1, provides the possibility to integrate with virtual reality technology. This integration allows the audience to dynamically recast movies in real-time while they are being watched in theaters.

14. The system of claim 1, provides the possibility to create and construct computer-generated virtual actors using artificial intelligence and deep fake techniques. These actors possess attributes that mirror the visual, audio, and acting style of the user and/or another entity.

15. The system of claim 1, provides the possibility to create a movie by selecting elements from existing films or TV shows. In this context, users can generate a movie by defining the genre, offering a brief idea, and specifying actors. The system then assembles the movie by extracting content from existing media and seamlessly editing it together.

16. The system of claim 1, provides the possibility to change the original language of media content to a preferred one, all while preserving the original voice of the cast.

17. The system of claim 1, provides the possibility for movies and TV shows to be crafted with actors in green suits, while granting users the ability to cast the actors according to their preferences.
